(19) United States
(12) Patent Application Publication
(10) Pub. No.: US 2015/0356860 A1
(43) Pub. Date: Dec. 10, 2015

(54) SYSTEMS AND METHODS FOR AUTOMATICALLY REPORTING LOCATION CHANGE IN USER MONITORING SYSTEMS

(71) Applicant: Integrity Tracking, LLC, Boca Raton, FL (US)

(72) Inventors: Jean Robichaud, Boca Raton, FL (US); Robert S. Flippo, Boca Raton, FL (US)

(21) Appl. No.: 14/530,321

(22) Filed: Oct. 31, 2014

Related U.S. Application Data
(60) Provisional application No. 62/008,309, filed on Jun. 5, 2014.

(51) Int. Cl. G08B 25/01; G08B 25/10

(52) U.S. Cl. CPC G08B 25/016; G08B 25/10

(57) ABSTRACT

The present disclosure is a user monitoring system that has a wearable device coupled to a user and configured for actuation in the event of an emergency and a base station configured for transmitting a system ready message when an operational status change occurs. In addition, the system comprises a processor that receives the system ready message, and in response to receiving the system ready message, performs a location check to determine when the base station is located at a first location as indicated in a user's profile data. Further, the processor performs a change of location operation for updating user's profile data when the location check indicates that the base station is in a second location.

### CROSS REFERENCE TO RELATED APPLICATION

This application claims priority to U.S. Provisional Patent Application Ser. No. 62/008,309 entitled Systems and Methods for Automatic Location Change Reporting of an Emergency Response System and filed on Jun. 5, 2014, which is incorporated by reference in its entirety.

### BACKGROUND

Personal Emergency Response Systems (PERS) typically comprise devices that are used for providing fast response to elderly or disabled who are in need of medical assistance. For example, many PERS comprise a wearable pendant with a button that, when actuated, initiates a signal for help. The PERS typically comprise a base station that resides in the home of the elderly/disabled person and provides connectivity to a service provider via a hard wired phone line connection over a public switched telephone network (PSTN).

A typical PERS includes the wearable pendant, the base station or other type of console device, the PSTN or mobile network (in systems that employ cellular transmission), a centralized receiver or server for communicating with base station or wearable pendant, automated security software, and emergency response operators. Each of these components work together to provide an emergency response application.

Often, the user's location, e.g., the location where the user will desire the emergency services, is provided to the centralized server during a set up process. In this regard, the user's home address, for example, is used as the location to send help in the event of an emergency. Since the system does not provide any other indication of the user's present location, it is crucial that the address be correct for proper dispatch of help. Typically, the receipt of the location to which the user desires emergency response is manually entered either by an installer or a system user at the centralized servicer.

If the user moves to a new location, taking with him the wearable pendant (alarm device) and the base station and fails to notify the response center, there is a high likelihood that the user's previous address will be responded to in the event that the wearable pendant is actuated. Thus, the user will not receive the help that is needed because emergency personnel will be sent to the previous location of the user.

### SUMMARY

The present disclosure is a user monitoring system that has a wearable device coupled to a user that is configured for actuation and a base station configured for transmitting a system ready message when an operational status change occurs. Further, the system has a processor configured for receiving the system ready message, and in response to receiving the system ready message, performing a location check to determine when the base station is located at a first location as indicated in a user's profile data stored in memory, the processor further configured to perform a change of location operation for updating user's profile data when the location check indicates that the base station is in a second location.

Further, the present disclosure may be conceptualized by the following method: (a) transmitting, by a transceiver in a base station, a system ready message in response to an operational status change; (b) receiving, by a processor, the system ready message; (c) in response to receiving the system ready message, performing, by the processor, a location check to determine if the base station is located at a first location as indicated in a user's profile data; and (d) performing a location change operation, by the processor, when the base station in located at a second location.

### BRIEF DESCRIPTION OF THE DRAWINGS

The present disclosure is described with reference to the accompanying drawings. The systems and methods described can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram depicting a personal emergency response system using a public switched telephone network (PSTN) in accordance with an embodiment of the present disclosure.

FIG. 2 is a block diagram depicting a personal emergency response system (PERS) using a cellular network in accordance with another embodiment of the present disclosure.

FIG. 3 is a block diagram of the base station depicted in FIG. 2.

FIG. 4 is a block diagram of a back end server depicted in FIG. 2.

FIG. 5 is a flow chart depicting architecture and functionality of the system such as is depicted in FIGS. 1 and 2.

### DETAILED DESCRIPTION

The present disclosure describes systems and methods for facilitating automatic notification of a system move to allow a response center the opportunity to update the location in a backend system to the accurate location. Such a system is less error prone and thus safer.

In one embodiment of the present disclosure, an exemplary personal emergency response system (PERS) is installed at a user's home. In such an embodiment, the address of the user's home is used as the location to which to dispatch help in the event of an emergency scenario. Exemplary scenarios may include, for example, the user elects to summon help by actuation of a button on a pendant or the system detects a fall.

If the user moves the PERS to a new location, such as a summer home, and does not notify the response center, there is a high likelihood of dispatching emergency help to an incorrect address in the event an emergency scenario occurs. The present disclosure describes systems and methods for automatically notifying the response center in the event the user moves the PERS to a different location than the user's home.

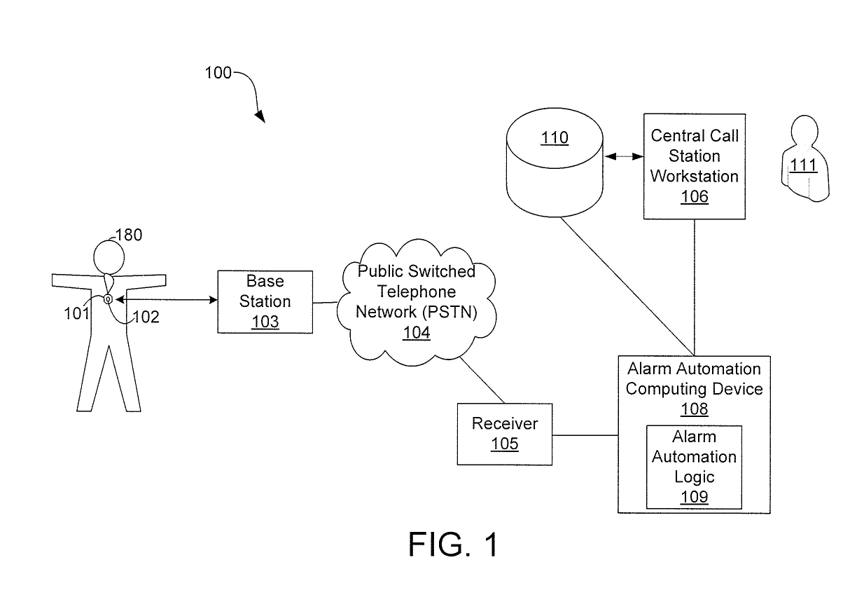

An exemplary PERS 100 is depicted in FIG. 1. The exemplary PERS 100 comprises a pendant 101 worn by a user 180. The pendant 101 may be worn about the neck of the user 180, as shown in FIG. 1.

The pendant 101 comprises a button 102 that may be actuated by the user 180 in the event of an emergency, e.g., a fall from which the user cannot recover without help, and the user actuates the button 102. Note that the pendant 101 may comprise resident logic (not shown) stored in memory (not shown) that automatically detects a fall thereby eliminating the necessity for the user 180 to actuate the button 102.

Further note that while the pendant 101 is shown and described throughout the present disclosure, other types of devices may be used in other embodiments. For example, the pendant may instead be a waist belt, a chest belt, or a wrist device. Description of the pendant 101 as the device configured for actuation by the user is not intended to be limiting.

The PERS 100 further comprises a base station 103 that is communicatively coupled to a receiver 105 via a public switched telephone network (PSTN) 104. Additionally, the PERS 100 comprises an alarm automation computing device 108 and a central call station workstation 106. The alarm automation computing device 106 is communicatively coupled to a database 110 and the central call station workstation 106.

In the PERS 100, the emergency button 102 is coupled to a wireless transceiver (not shown). Any type of transceiver known in the art or future-developed configured for transmitting radio signals may be used. In the embodiment depicted in FIG. 1, the transceiver is contained within a housing of the pendant 101.

The transceiver is coupled wirelessly to the base station 103. In this regard, the base station 103 also comprises a transceiver (not shown) for communicating with the transceiver resident in the pendant 101. Relevant to the communication scheme employed between the transceiver in the pendant and the transceiver in the base station 103, the wireless technology and protocol employed can be any type of technology and/or protocol known in the art including ZigBee, Z-wave, and Wi-Fi.

In one embodiment, the PERS 100 employs an Amplitude Shift Keyed (ASK) modulation scheme at 315 MHz or 433 MHz. In this regard, lower frequencies are used for their behavior indoors and their ability to permeate normal home construction. In such an embodiment, the transceiver in the pendant 101 may convey to the base station 103 a signal comprising data indicative of a unique address identifier (identifying the hardware) and an emergency button actuation, i.e., actuation of button 102.

As indicated hereinabove, the pendant 101 is wirelessly and communicatively coupled to the base station 103. Thus, upon actuation of the button 102, the transceiver in the pendant 101 sends a signal to the base station 103. The base station 103 receives the signal and behaves accordingly, as further described herein.

As indicated hereinabove, the signal transmitted by the pendant 101 may comprise data that indicates an emergency button press. The signal may also comprise other data, e.g., a hardware identifier. Upon receipt of the signal, the base station 103 follows an emergency response protocol for handling the data received indicating that the emergency button 102 has been pressed. The emergency response protocol followed by the base station 103 may vary in other embodiments; however for purposes of this disclosure the protocol is as follows.

First, the base station 103 determines if an existing alarm is currently in progress. Note that the base station 103 comprises logic (not shown) that may include hardware, software, firmware, or a combination thereof for processing the event.

If no alarm is currently in progress, the base station 103 provides audible and visual indication to the user 180 that an alarm is active and then attempts to seize a connected telephone line for placing a call to the receiver 105. If the call is successful and is connected to the receiver 105, the base station 103 transmits data describing the alarm via the PSTN 104 to the receiver 105. Such data may include, but is not limited to, a user account identifier and a type of alarm.

Alternatively, the base station 103 transmits data indicative of hardware identifiers, e.g., a hardware identifier of the pendant 101 or the base station 103. In such an embodiment, alarm automation logic 109, which resides on the alarm automation computing device 108, looks up user profile data by referencing the assigned hardware identifier in the database 110. In this regard, the installer or some other user of the central call station workstation 106 or alarm automation computing device 108 may enter data into the database 110 defining the user's profile prior to or upon installation. The user's profile data may include, but is not limited to, the user's telephone number, the user's address, the user's name, or a hardware identifier identifying the hardware installed at the user's residence.

Thus, upon receipt of an alert signal containing user identifying information, and a call, the logic 109 may look up the user's profile data in the database 110 based upon the information received. The process of combining the alert/phone call with a user profile is known in the industry as “call binding”. For example, if a base station hardware identifier is provided, the logic 109 may search the database 110 for the phone number of the call received to retrieve the user's profile data.

Note that the receiver 105 is a specialized receiver, such as an Osborne Hoffman receiver. The receiver 105 answers a call from the base station 103 that travels to the receiver 105 over the PSTN 104. In this regard, the receiver 105 processes the incoming transmission from the base station 103. The receiver 105 communicates with the alarm automaton logic 109, such as GE Mastermind, DICE, or Stages. The automation logic 109 accesses the associated user's profile data, as described hereinabove, and queues the alarm for servicing by a call station operator 111. Thus, when the next operator 111 becomes available for handling the event, the alarm automation computing logic 109 notifies the operator 111 through the central call station workstation 106 being manned by the operator 111. The operator 111 accepts the alarm and connects an audio talk path to the end user, for example through the PSTN 104.

Note that the present disclosure does not require a human operator 111. In this regard, interactive voice recognition (IVR) software could be used to interact with users or to help triage users that cannot be assisted by an IVR operator.

The operator 111 at the central call station is responsible for managing the situation and determining if emergency response is required. The operator 111 may call associated caregivers or responders that were listed at the time of account creation. This might include a son, daughter, friend, or neighbor of the user. If necessary, the operator 111 will also contact the corresponding Public Service Answering Point (PSAP) to dispatch local emergency response. The PSAP is the ten-digit equivalent of the local [to the user] 9-1-1 exchange and is typically associated with the user's profile data at installation time. If no one is able to be reached or assistance is requested, the Call Center will dispatch EMS. The location to dispatch will be the location in the user's profile data.

Note that the user 180 may change locations by moving the base station 103 to a new location. At the new location, the user 180 may wear his/her wearable device 101, and use as according to the description hereinabove. If the user moves to a new location, the system 100 executes a process to determine that the user is in a new location so that emergency calls are responded to at the correct location.

In this regard, when the base station 103 is plugged in at the new location and power is provided to the base station 103, the user may be pre-instructed upon a move to a new location to perform a test of the system. Methods for testing by the user various components of the system 100 are described in U.S. patent application Ser. No. 14/157,510 entitled Self-Test Emergency Response Systems and Methods, and filed on Jan. 16, 2014, which is incorporated herein by reference.

In this regard, the user 180 is instructed to perform the test when the base station 103 is powered on by actuating a test button, for example. There may be other devices or methods for initiating the test in other embodiments of the present disclosure. Upon initiation of the test, the base station 103 places a call via the PSTN to the receiver 105. The call initiated includes the caller identification (caller ID) for the base station 103 and user or hardware identifiers identifying the base station 103. The receiver 105 transmits the user or hardware identifier and, if equipped to do so, the originating phone number (extracted from the caller ID) to the alarm automation logic 109. The alarm automation logic 109 determines if the user or hardware identifier is associated with the originating phone number by searching the database for the user or hardware identifier. If the originating phone number of the incoming call does not match the telephone number associated with the user in the database 110, then the logic 109 may transmit a message to the central call station workstation 106 indicating a potential location change. The operator 111 may then call the customer at the caller ID to inquire if location for responding to emergencies has changed. Accordingly, the operator 111 can update the database 110 with the new location information, including the caller ID associated with the new location.

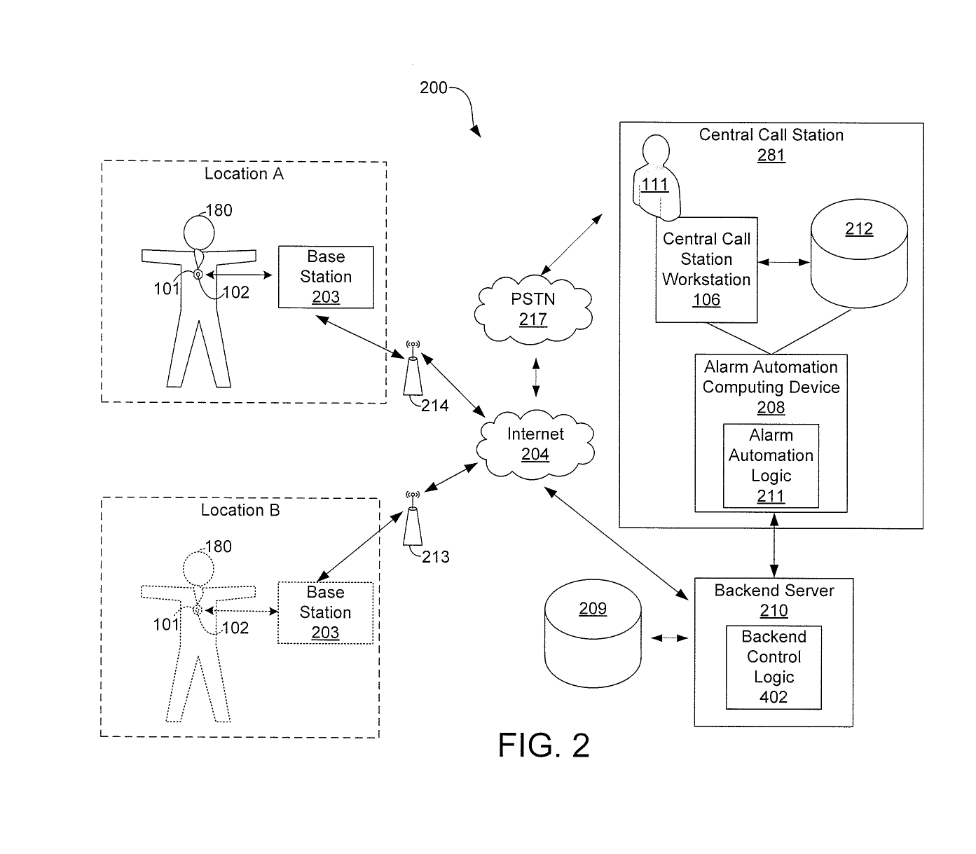

FIG. 2 is a PERS 200 in accordance with an embodiment of the present disclosure, wherein the PERS 200 is configured for automatically ensuring integrity of the PERS 200 if there is a location change of the user and his corresponding equipment (the pendant 101 and the base station 203), e.g., if the user moves from Location A to Location B. In this regard, if the user and his corresponding equipment are initially installed at Location A, the user may thereafter move with his equipment to Location B. To ensure integrity of the system 200, the PERS 200 will perform one or more operations that automatically occur to ensure that the PERS 200 is still capable of responding to an emergency event related to the user. In such an embodiment, the PERS 200 employs cellular technology to effectuate the operations that ensure that the emergency event is responded to effectively.

The PERS 200 comprises the pendant 101 with the button 102 as described with reference to PERS 100 (FIG. 1). In addition, the PERS 200 also comprises a base station 203; however, the base station 203 is configured for communicating over cell towers 213 or 214 to an Internet 204. Further, the PERS 200 comprises a backend server 210 that is configured for receiving data indicative of events from the Internet 204 and responding accordingly, which is described further herein. Note that the backend server 210 comprises backend control logic 402 that is configured for communicating with a backend database 209 and an alarm automation computing device 208.

Additionally, the PERS 200 comprises a central call station 281. The central call station 281 may be, for example, a building that houses operators 111 (while only one is shown a plurality of operators may be used). The central call station further comprises a central call station workstation 106 at which the operator 111 may be alerted of emergency events. In addition, the central call station 281 further comprises a central call station database 212 and an alarm automation device 208 on which resides alarm automation logic 211. Note that the alarm automation logic 211 may be hardware, software, firmware, or a combination thereof.

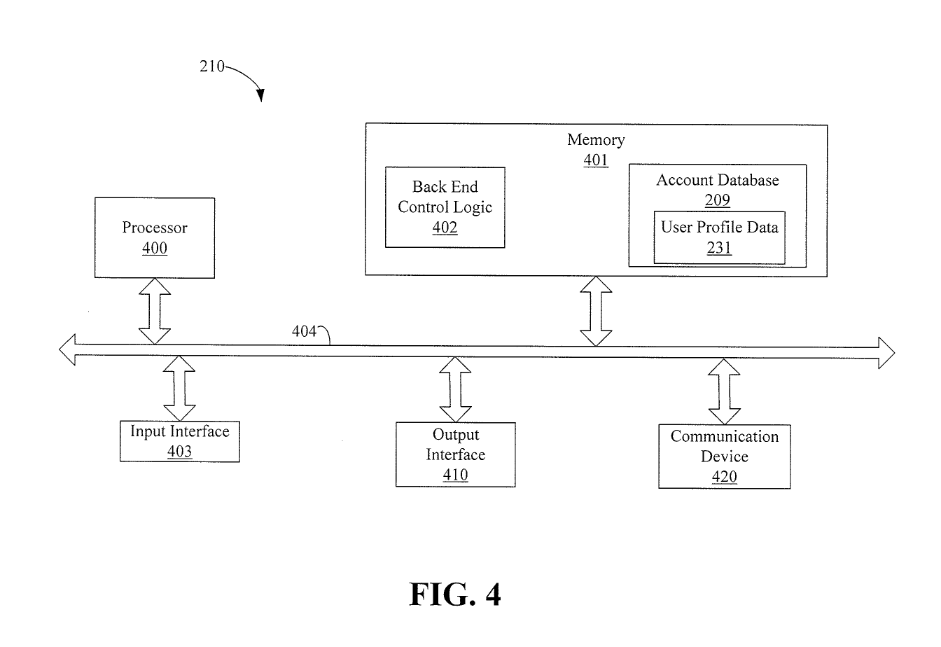

Note that the backend server 210 is indicated as a server, which means in the present disclosure a computing device configured for receiving data, processing data, and transmitting data. Thus, the backend server 210 may be any type of computing device known in the art or future-developed for performing such functions. The backend server 210 is described in more detail with reference to FIG. 4 herein.

In the PERS 200, the base station 203 is not connected directly to a PSTN 217 but instead utilizes a cellular radio housed in the base station 203 (not shown). The cellular base station 203 has two distinct advantages when compared to other types of PSTN-connected base stations: First, a cellular base station 203 allows installation of the PERS 200 at a location where a telephone line is not present or convenient, such as the case when a voice over internet protocol (VoIP) phone line is used or a cell phone is the only phone in the residence. Secondly, a cellular base station 203 allows additional information to be conveyed to the backend server 210 due to the increased bandwidth available for the transfer of data.

Similar to the PERS 100 (FIG. 1), an emergency event may occur, e.g., the user 180 presses the button 102 or logic in the pendant detects a fall of the user 180. The pendant 101 transmits a signal comprising data indicative of the event that is received by the base station 203. In this regard, in one embodiment, the pendant 101 comprises a transceiver (not shown) that transmits the signal, and the base station 203 comprises a transceiver (not shown) that receives the signal.

Upon receipt of the signal indicating an emergency event, the cellular base station 203 determines if an existing alarm (i.e., a previous emergency event) is currently in progress. If no alarm is currently in progress, the cellular base station 203 provides audible and visual indication to the user 180 that an alarm is active. The cellular base station 203 then transmits data indicative of the user's identification and alarm type to the backend server 210. Note that the data indicative of the user's identification may be, for example, a hardware identifier, or any other type of data that may be used to uniquely identify the user.

The transmission method to the backend server 210 may employ any number of data transmission protocols known in the art or future developed. For example, a text-based protocol using standard Internet protocols such as transmission control protocol/Internet protocol (TCP/IP) may be used. An example payload message that may be transmitted to the backend server 210 using the cellular network as follows:
<IMSI>|ALERT|EP|1|∥
   where IMSI means an International Mobile Subscriber Identifier (IMSI), which is a unique identifier assigned to the cellular equipment in the base station 203 when the device is activated. This particular IMSI may be used to identify the user 180 by a central call station workstation 106 or the backend server 210, which is described further herein. The data identified as “ALERT” denotes an emergency alarm, i.e., an emergency event has occurred, and EP denotes the type of alarm (e.g., Emergency Pendant press). This represents just one exemplary format for encoding, and the present disclosure is not limited in any way by the use of other methods for transmission to the backend server 210. As an example, the cellular network comprising towers 213 and 214 may be a Global System for Mobile Communications (GSM) network. Or, as another example, the cellular network comprising towers 213 and 214 may be a Code Division Multiple Access (CDMA) network in another embodiment of the present invention. Other types of networks using other types of messages may be used in other embodiments.

The cellular base station 203 transmits a signal indicative of the alarm to the cell tower 214, which is passed through the Internet 204 to the backend server 210. The backend server 210 then presents the alarm to the central station alarm automation logic 211 resident on the alarm automation computing device 208.

Between the backend server 210, a call center operator 111, and the alarm automation logic 211, the following tasks are performed: 1) resolution of the appropriate PSAP for purposes of dispatch and 2) connection of audio between the call center operator 111 and the end user 180. The order of these steps can vary. Note that the system 200 may further comprise a PSTN 217, and the operator 111 may connect audio to the end user 180 through the PSTN 217 and the cell tower 214. In this regard, the audio path established could be with the base station 203 or with the user's telephone, e.g., a mobile device identified for the user in a central call station database 212.

Unlike the PERS 100 where the call in response to an emergency event originates by the base station 103 (FIG. 1), in PERS 200 the call (i.e., the audio path) is initiated and established by the call center operator 111. Notably, the data indicative of the alarm that was received by the backend server 210 was delivered out of band of the call that is subsequently established by the operator 111. Thus, there is more certainty that the call is bound to the actual alarm. However, the present disclosure is not limited in any way and could apply to an embodiment where calls originate outbound from the base station 103.

In accordance with the present disclosure, when installation of the user's equipment occurs, i.e., the base station 203 and corresponding pendant are set up to operate, user profile data (not shown) identifying the user, including data describing Location A, i.e., the user's address, are stored in the database 209 and/or database 212. During the course of user's enjoyment of his equipment, he may move his equipment to Location B, which as indicated above may be, for example, his summer residence or he has permanently moved to a managed care facility. Without further action, if an emergency event occurs after the move to Location B, the operations performed based upon receipt of data indicating an emergency event, e.g., the operator 111 dispatching emergency personnel to Location A, may not be effective because data identifying Location A is what is associated in the databases 209 and 212 with the user 180.

However, in the present disclosure, there are a number of change in location events that may occur upon a relocation of the equipment, i.e., the pendant 101 and the base station 203. The change in location events may be communicated to the backend server 210 so that the backend server can take action related to the change in location event.

As one example, when the user powers on his base station 203 at Location B, the base station 203 transmits a system ready message to the backend server 210 via the cell tower 213 and the Internet 204. In one embodiment, the system ready message may include location data based upon a global positioning system (GPS) resident on the base station 203. In another embodiment, the backend server 210 may request the subscriber's location for the most recent event using a location base service (LBS). When using LBS, an approximate location of the subscriber is provided typically as a Cell Identification (Cell ID) associated with cell towers 214 or 213. The Cell ID is a generally unique number used to identify each cell tower within a Location area code (LAC). Note in GSM networks, the cell tower is often referred to as a Base transceiver station (BTS) in a GSM network. We will use the term “cell tower” for more general description without regard to CDMA or GSM networks. For the purpose of the present disclosure, the Cell ID corresponds to the nearest cell tower 213 or 214 for the subscriber.

In this example, the backend control logic 402 compares the location data stored on databases 209 and 212 corresponding to the user's profile with the location data received from the LBS service in response to the system ready message. The comparison is used to determine if the user has changed locations, e.g., moved from Location A to Location B. If such a move has occurred, the backend control logic 402 notifies the alarm automation logic 109 of such move.

While the system ready message was described in response to an initial power on; more generally, the system ready message transmitted by the base station 203 is in response to an operational status change, which might signify a potential relocation of the base station. As another example of a an operational status change, the base station 203 may experience a cell tower handoff when the equipment moves from Location A to Location B. Note that in a cellular network, such as the cellular network comprising cell towers 213 and 214, the wireless transceiver in the base station 203 “registers” with the cell network. Once registered, the base station may communicate with any tower in the network. And when moving from tower 213 to 214, the cellular transceiver resident on the base station 203 will undergo a “handoff” (also known as “handover”) between towers. In this regard, when the base station 203 is at Location A it will experience a handoff to cell tower 214. When the base station 203 is moved to Location B, the base station 203 will experience a handoff to cell tower 213. In such an example, the base station 203 may comprise a battery (not shown) that ensures that the wireless transceiver is still powered in the event that the base station 203 is unplugged and moved. In such a scenario, the base station 203 may be configured to automatically transmit a system ready message to the backend server 210 indicating its operational status change as a result of a handoff to cell tower 214 when it moves from the area covered by cell tower 214 to the area covered by cell tower 213. In response, the backend control logic 402 will once again query location base services to determine the new location. If the location has changed with respect to the user's address, the backend control logic 402 transmits a message to the alarm automation logic 211 that the base station 203 has changed locations.

Note that use of powering on of the base station 203 and a handoff with a cell tower to notify the backend server 210 of an operational status change are exemplary events that may be used to determine a potential change in location. Other operational status changes may be used in other embodiments of the present disclosure to trigger transmission of a system ready message to the backend server 210.

Regardless of the manner in which the backend server 210 receives a notification of a change in location of the base station 203, the backend control logic 402 transmits a message to the alarm automation logic 211. The alarm automation logic 211 receives the message from the backend control logic 402. Upon receipt, any number of change of location operation may be taken in response to the change in location.

In one embodiment, the operator 111 is instructed by the alarm automation logic 109 to call the user 180 to obtain the exact location data so that the user profile data in database 209 and/or 212 may be updated. In such a scenario, the alarm automation logic 211 transmits a message to the central call station workstation 106 requesting the operator to take the action. Upon receipt, the operator 111 may phone the user 180 to request the information related to Location B.

In another embodiment, the back end server 210 may be configured to perform other operations in response to the change in location from Location A to Location B. For example, the alarm automation logic 211 may automatically place a call to the user's phone number identified in the database 212 and play an automated message requesting the user to call the central call station 281 (customer service) in order to update their new location data. In another embodiment, the alarm automation logic 211 may transmit an email to the email address of the user obtained from the database 212 asking the user 180 to call and update the location data. In another embodiment, the alarm automation logic 211 may instruct an operator (or other personnel) to send a letter to the user 180 requesting the new location data. In yet another embodiment, when the user 180 next logs onto the PERS system's website (not shown), a message may be transmitted to the user via the website requesting the new location data.

Note these are just examples of communication with the user 108 regarding a change in location. Other types of methods may be used in other embodiments to request new location data from the user 180.

In another embodiment, the back end control logic 402 may notify customer service in the form of an email, or using some off-the-shelf issue management software to queue a representative to contact the user and reconcile the address on file. In this regard, the method by which the system 200 notifies customer service may be any type of electronic method known in the art or future-developed for transmitting a message to customer service.

Note that the database 209 and the database 212 store a plurality of users' profile data. Further note that periodically, the database 209 may be synced with the database 212 to ensure that the data is consistent throughout the PERS 200.

In another embodiment the user profile data may contain multiple valid addresses corresponding to the user. This may be the case when a user provides a well-known summer residence at the time of initial installation. In this fashion, back end control logic would sequentially compare the location information with each address on file. If one address on file is determined to be the address that the base station currently resides, then no human interaction is required by customer service or central station operators. Instead, the database can be updated to note the current active address (e.g. modifying an “active address” flag in the data base).

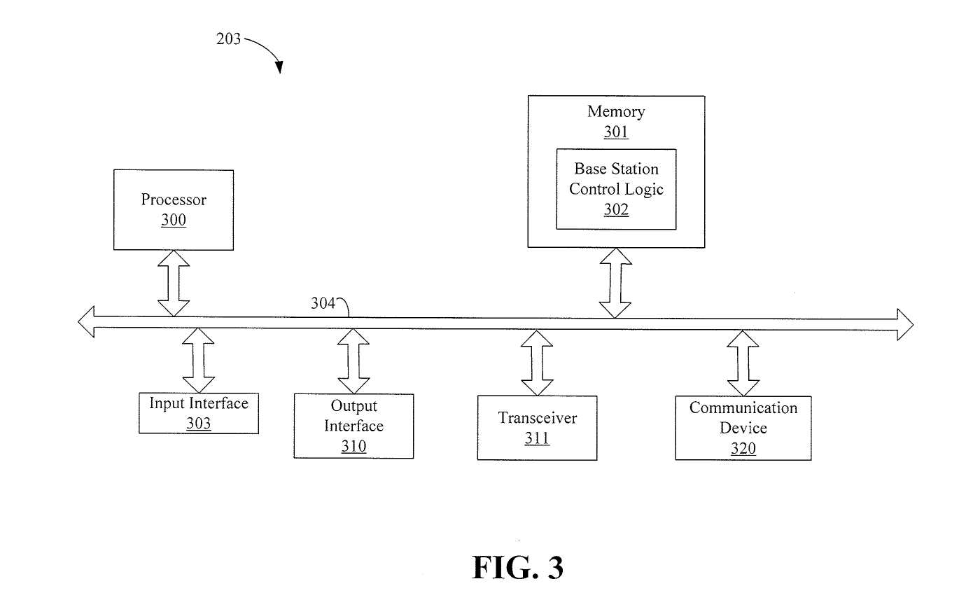

FIG. 3 is a block diagram of an exemplary base station 203 (FIG. 2) for implementation in the system 200 (FIG. 2). The base station 203 comprises base station control logic 302, an input interface 303, an output interface 310, a transceiver 311, and a communication device 320. In addition, the base station 203 comprises at least one conventional processor 300, such as a digital signal processor (DSP) or a central processing unit (CPU), which executes programs, performs data manipulations, controls operations, and otherwise communicates with and drives the other elements within the base station 203 via a local interface 304, which can include at least one bus.

In the embodiment depicted, the base station control logic 302 is stored in memory 301 and is configured to operate the base station 203. Note that the control logic 302 may be implemented in hardware, software, firmware, or a combination thereof. In FIG. 3, the control logic 302 is illustratively shown as being implemented in software and stored within the memory 301. Note that when at least a portion of the control logic 302 is implemented in software, the processor 300 is configured to execute instructions of the control logic 302.

The input interface 303 enables a monitored user 101 or an installer (not shown) to input information to the base station 203. An exemplary input interface 303 may be, for example, a keyboard, keypad, or an emergency button, i.e., a button that is selectable by the monitored user.

The output interface 310 enables a monitored user or installer (not shown) to receive information from the base station 203. An exemplary output interface 310 may be, for example, a display device that displays information or a speaker that provides voice commands or alarm tones of the user.

The communication device 320 allows data to be received and transmitted between the base station 203 and the backend system 210 (FIG. 2). In this regard, the communication device 320 may be, for example, a cellular radio transceiver that connects the base station 203 to the cell tower 213 or 214. These are exemplary devices, and any type of communication device known in the art or future-developed may be used to communicatively couple the base station 203 to the backend system 210 or the receiver 206

The transceiver 311 is a device that effectuates communication with the pendant 101 (FIG. 2). In this regard, the transceiver 311 may be, for example, a radio transceiver that allows communication between the pendant 101 and the base station 203.

FIG. 4 is a block diagram illustrating a backend system 210 for implementation in the PERS 200 (FIG. 2). The backend system 210 comprises backend control logic 402 and the account database 209 all stored in memory 401. Note that the account database 209 is shown as stored in memory 401 of the backend system 210; however, the account database 209 may be separate and apart from the backend system 210, as is shown in FIG. 2. For example, the account database 209 may be resident on a separate computing device (not shown). For simplicity and exemplary purposes for discussion, the account database 209 is shown as being stored in memory 401 of the backend system 210.

The account database 209 stores user profile data 231. The user profile data 231 comprises data indicative of a plurality of users. Each user's user profile data 231 comprises data indicative of the user's account, the user's address (Location A (FIG. 2), hardware identifiers associated with the user's base station 203 (FIG. 2), the user's telephone number, or any other data associated with the user.

The backend system 210 further comprises an input interface 403, an output interface 410, and a communication device 420. In addition, the backend system 210 comprises at least one conventional processor 600, such as a digital signal processor (DSP) or a central processing unit (CPU), which executes programs, performs data manipulations, controls operations, and otherwise communicates with and drives the other elements within the backend system 210 via a local interface 404, which can include at least one bus.

The communication device 420 allows data to be received and transmitted between the backend system 210 (FIG. 2) and the receiver 206 (FIG. 2) and/or the base station 203 (FIG. 2). In this regard, the communication device 420 may be, for example, a radio transceiver that connects the backend system 210 to the cell towers 213 and 214 via the Internet 204. These are exemplary devices, and any type of communication device known in the art or future-developed may be used to communicatively couple the backend system 210 to the Internet 204.

In the cellular PERS system 200 depicted in FIG. 2, the initial user's location, e.g., Location A, is established during the account setup. Data indicative of the user's initial location is entered into the backend system 210 as part of the user's profile data 231, which is stored in account database 209 (FIG. 2) as described hereinabove.

If the user moves the cellular base station 203 and corresponding pendant 101 to Location B (FIG. 2), the base station 203 is powered down by unplugging it from an A/C power outlet.

When the base station 203 is powered up after being moved to Location B, a message indicating that the system is powered on and ready or that a power-on event has occurred (hereinafter referred to as a “system ready message”) will automatically be sent to the backend system 210 via a cellular data channel or other persistent data connection such as Ethernet by the base station 203. In the embodiment shown, the system ready message is transmitted via the cell tower 213 and Internet 204 to the backend system 210. Notably, cell tower 214 services the area in which location A resides, whereas cell tower 213 services the area in which location B resides.

Upon receipt of the system ready message, the backend system 210 requests the subscriber's location for the most recent event using a location base service (LBS) to obtain a Cell ID or, if present, global positioning system (GPS) data from the cellular base station 203. In this regard, the base station 203 may comprise a GPS so that the base station 203 may transmit data indicative of the current GPS coordinates of the location of the base station 203.

The backend control logic 420 compares the data indicative of the location of the base station 203 received to the user's profile data 231 indicative of the user's address. If the data indicative of the location matches the data indicative of the user's address in the user's profile data 231, then the backend system 210 determines that a location change has not taken place and no further action will be taken.

If, however, the location data is different than the location stored in the user's address of the user's profile data 231, an event is automatically sent to the alarm automation logic 211 indicating that a system has been moved from its initial defined address at Location A (FIG. 2) to a new address, Location B (FIG. 2).

Upon notification of the operator 211 (FIG. 2) via a central call station workstation 106 by the logic 211, the operator 111 at the central call station can determine the current location of the base station 203 by calling the user and updating the current location in the database 212 from Location A to Location B. In one embodiment, the operator's central call station workstation 106 may be used to access the database 212 and update the user's profile data from Location A to Location B.

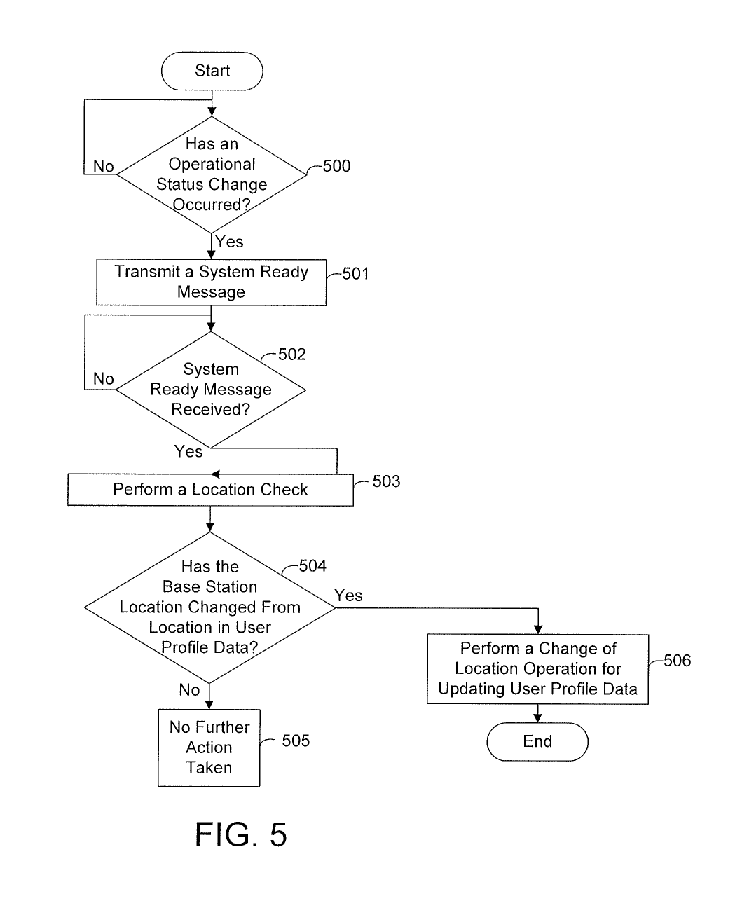

FIG. 5 is a flow chart depicting exemplary architecture and functionality of the systems 100 (FIG. 1) and 200 (FIG. 2). Note that while there are two embodiments of the systems (as depicted in FIG. 1 and FIG. 2), the present disclosure encapsulates a method for both embodiments.

In step 500, the system 100 (FIG. 1) or 200 (FIG. 2) determines when an operational status change occurs. As described hereinabove, an operational status change can be one of any number of events. As a particular example, powering on of the base station 103 (FIG. 1) or 203 (FIG. 2) may be an operational status change. In this example, a user may desire to move his/her base station 103 or 203 from its residence, for example, (Location A) to a summer home or any other location different than the address at which the base station 103 or 203 currently resides (Location B). In so doing, the user would necessarily power off the base station 103 or 203 by either actuating a power switch or unplugging the base station 103 or 203.

When the user arrives at Location B, the user plugs the base station 103 or 203 into a power outlet (not shown), and the base station 203 is turned back on. Note that the powering on of the base station 103 or 203 is an exemplary operational status change. Other types of operational status changes are possible in other embodiments, e.g., in regards to FIG. 2 the base station 203 may handoff to a different cell tower than the cell tower serviced by Location A.

In step 501, the base station 103 or 203 transmits a system ready message to the alarm automation device 108 (FIG. 1) or the backend server 210 (FIG. 2), respectively, indicating that the base station 103 or 203 has been powered on.

If a system ready message is received, as indicated in step 502, the alarm automation device 108 or the server 210 performs a location check, as indicated in step 502. The location check is to determine if the base station 103 or 203 is now located at a different address than the one at which it was previously operating and which is noted in the user's profile data.

In one embodiment, as described hereinabove, the location check may be done by obtaining a unique Cell ID available from a network location base service (LBS). Notably, the Cell ID identifies a specific cell tower inside the GSM Network (also known as a Base Transceiver Station) or CDMA network with which the base station 203 is communicating. Upon receipt of a system ready message from the base station 203, the backend control logic 402 can request the location/Cell ID of the base station 203.

Note that in one embodiment, GPS data identifying the location of the base station 203 may be transmitted in the system ready message or the backend control logic 402 (FIG. 4) may transmit a request for GPS data. The backend control logic 402 compares the location for which data is received (Location B) to the location presently stored in the user's profile data 231 (FIG. 4) (Location A) in the database 209.

Note that if as indicated above the location data received is the Cell ID of the base station 203, the backend control logic 402 translates the Cell ID to latitude/longitude coordinates. If the currently stored user location is stored as a street address, the backend control logic 402 may also convert the street address to latitude/longitude, and the backend control logic 402 determines whether the current location and the stored location differ by some predefined radius X (e.g., two miles) by comparing the latitude/longitude data. Typically, the LBS will provide a radius of uncertainty when returning location information and, in practice, the predefined radius may be chosen so that it is very close or identical to the radius of uncertainty. Alternatively, mapping or location services can be queried to determine if the residence address stored in the database is contained within the circle defined by the LBS-provided latitude/longitude and the radius of uncertainty. If the backend control logic 402 determines that the location has changed, the backend control logic 402 transmits data to the alarm automation computing device 108 indicating that a change has occurred in the location of the identified user. In response, an operator at the central call station 281 (FIG. 2) can contact the user to verify. In another embodiment, the location check performed may be performed over a PSTN, as described with reference to FIG. 1. In such an embodiment, a caller ID and a user or hardware identifier may be used to perform the location check. In this regard, the alarm automation logic 109 may look up the user in the database 110 using the user or hardware identifier and compare the phone number associated with the user's profile to the provided Caller ID.

In another embodiment, the user's profile may also store the last known Cell ID associated with the user location file. In this fashion, the location check performed by the back end logic may be simplified. It need not convert addresses to latitude and longitude coordinates and does not need to be concerned with whether the location has changed by an appreciable amount beyond the error of uncertainty. Instead it can check simply if the Cell ID has changed from the last known location.

If the alarm automation logic 109 or the backend control logic 402 determines that the location has not changed, as indicated in step 504, no further action is taken, as indicated in step 505.

However, if a location change has occurred, as determined in step 504, the alarm automation logic 109 or the back end control logic 402 may perform a change of location operation. Such an operation may be one that updates the user's profile data, as indicated in step 506. As described herein, the change of location operation may be one of many different types of operations. As mere examples, the operator may be automatically notified to contact the user, an automated email may be sent to the operator or to the user to request new location information, or a request may sent to an operator to transmit a letter to the user.

What I claim is:

1. A user monitoring system, comprising:
a wearable device coupled to a user and configured for actuation in the event of an emergency;
a base station configured for transmitting a system ready message when an operational status change occurs; and
a processor configured for receiving the system ready message, and in response to receiving the system ready message, performing a location check to determine when the base station is located at a first location as indicated in a user's profile data stored in memory, the processor further configured to perform a change of location operation for updating user's profile data when the location check indicates that the base station is in a second location.

2. The user monitoring system of claim 1, wherein the operational status change is powering on the base station.

3. The user monitoring system of claim 1, wherein the operational status change is handoff to a second cell tower different that a first cell tower to which the base station was previously communicating.

4. The user monitoring system of claim 1, wherein the wearable device is a pendant and the pendant comprises a button configured for actuation.

5. The user monitoring system of claim 1, wherein the base station is further configured to transmit the system ready message over a cell tower.

6. The user monitoring system of claim 5, wherein the cell tower is configured for transmitting the system ready message over an Internet.

7. The user monitoring system of claim 4, wherein the processor is further configured for receiving the system ready message from the Internet.

8. The user monitoring system of claim 1, wherein the base station is configured to transmit the system ready message over a publicly switched telephone network (PSTN).

9. The user monitoring system of claim 6, wherein the processor is further configured for receiving the system ready message from the PSTN.

10. The user monitoring system of claim 9, wherein the processor is further configured to receive a caller identifier (caller ID) and a hardware identifier

11. The user monitoring system of claim 10, wherein the hardware identifier identifies the base station.

12. The user monitoring system of claim 10, wherein the hardware identifier identifies the or a user's account.

13. The user monitoring system of claim 10, wherein the processor is further configured to:
compare the caller ID with data indicative of a phone number in the user's profile data; and
determine the location of the base station based upon the comparison.

14. The user monitoring system of claim 1, wherein the change of location operation is transmitting an alert to an alarm automation device data indicating that the first location identified in the user's profile data is no longer accurate.

15. The user monitoring system of claim 14, wherein the alarm automation device is configured to transmit an alert to an operator, and the operator places a phone call to the user requesting updated location information.

16. The user monitoring system of claim 1, wherein the change of location operation is electronic mail and the processor is further configured to email the user requesting information regarding a change in location.

17. The user monitoring system of claim 1, wherein the change of location operation is notifying an operator to send a letter to the user requesting information regarding a change in location.

18. The user monitoring system of claim 1, wherein the change of location operation is displaying a notification to a display device when the user logs into a website requesting information regarding a change in location.

19. The user monitoring system of claim 1, wherein the base station further comprises a global positioning system (GPS) and the processor is further configured for transmitting location information from the GPS in the system ready message defining the location of the base station.

20. The user monitoring system of claim 19, wherein the processor is further configured for:
receiving the location information; and
comparing the location information received with the user's profile data.

21. The user monitoring system of claim 1, wherein the processor is further configured to transmit a request for a Cell Identifier (Cell ID) that defines a general location of the base station and determine a change in location, based upon a predefined radius.

22. The user monitoring system of claim 1, wherein the wearable device is further configured for transmitting a signal indicative of an emergency event when the wearable device is actuated and the base station is further configured for receiving the signal indicative of the emergency event, the base station comprising a cellular transceiver configured for transmitting a signal indicative of the emergency event.

23. A user monitoring method, comprising:
transmitting, by a transceiver in a base station, a signal indicative of a system ready message when an operational status change occurs;
receiving, by a processor, the system ready message;
in response to receiving the system ready message, performing, by the processor, a location check to determine when the base station is located at a first location indicated in user's profile data;
performing a change of location operation for updating the user's profile data when the location check indicates that the base station is in a second location.

24. The user monitoring method of claim 23, further comprising powering on the base station, wherein powering on the base station is the operational status change.

25. The user monitoring method of claim 23, registering, by the base station, with a second cell tower different that a first cell tower to which the base station was previously communicating, wherein the registration with second cell tower is the operational status change.

26. The user monitoring method of claim 23, further comprising transmitting the system ready message over a cell tower, by the base station.

27. The user monitoring method of claim 26, further comprising transmitting the system ready message over an Internet by the cell tower.

28. The user monitoring method of claim 27, further comprising receiving the system ready message from the Internet by the processor.

29. The user monitoring method of claim 23, further comprising transmitting the system ready message, by the base station, over a publicly switched telephone network (PSTN).

30. The user monitoring method of claim 29, further comprising receiving, by the processor, a caller identifier (Caller ID) and a hardware identifier.

31. The user monitoring method of claim 29, further comprising receiving the hardware identifier wherein the hardware identifier uniquely identifies the base station.

32. The user monitoring method of claim 29, further comprising:
comparing, by the processor, the caller ID with data indicative of a phone number in the user's profile data; and
determining a current location of the base station based upon the comparison.

33. The user monitoring method of claim 23, further comprising transmitting an alert to an alarm automation computing device data indicating that the first location is no longer accurate.

34. The user monitoring method of claim 33, further comprising transmitting, by the alarm automation computing device, an alert to an operator, wherein the operator places a phone call to the user requesting updated location information.

35. The user monitoring method of claim 23, wherein the change of location operation is sending an electronic mail, further comprising sending, by the processor, an electronic mail requesting information regarding a change in location.

36. The user monitoring method of claim 23, wherein the change of location operation is notifying an operator to send a letter to the user, further comprising sending, by the processor, a notification to the operator.

37. The user monitoring method of claim 23, wherein the change of location operation is displaying a notification to a display device when the user logs into a website, further comprising displaying, by the processor, the notification to the display device.

38. The user monitoring method of claim 23, wherein base station comprises a global positioning system (GPS), further comprising transmitting, by the base station, location information received from the GPS in the system ready message, the location information defining a current location of the base station.

39. The user monitoring method of claim 38, further comprising:
receiving, by the processor, the location information; and
comparing, by the processor, the location information received from the base station with the user's profile data.

40. The user monitoring method of claim 23, further comprising:
transmitting, by the processor, a request for a Cell Identifier (Cell ID) that defines a general location of the base station; and
determining, by the processor and based upon a predefined radius, when the second location of the base station is different than the first location.

41. The method of claim 23, further comprising:
transmitting a signal indicative of an emergency event when a wearable device worn by a user is actuated; and
receiving, by the base station, the signal indicative of the emergency event.
